(19) United States
(12) Patent Application Publication
(10) Pub. No.: US 2019/0095056 A1
(43) Pub. Date: Mar. 28, 2019

(54) Method and Apparatus for Locking Object in List, and Terminal Device

(71) Applicant: Huawei Technologies Co., Ltd., Shenzhen (CN)

(72) Inventor: Xiaobo Yu, Shenzhen (CN)

(21) Appl. No.: 16/092,169

(22) PCT Filed: Apr. 15, 2016
(86) PCT No.: PCT/CN2016/079398

§ 371 Date: Oct. 8, 2018

(51) Int. Cl. G06F 3/0482; G06F 3/0485; G06F 3/0488

(52) U.S. Cl. CPC G06F 3/0482; G06F 3/04883; G06F 3/0485

(57) ABSTRACT

A method and an apparatus for locking an object in a list, and a terminal device, where the method includes determining whether a floating control signal entered for a dynamic list is detected within a preset vertical area of a display, where the dynamic list includes a plurality of movable objects whose display locations are changeable, obtaining location information of the floating control signal or location information of the interface control signal when the floating control signal or the interface control signal is detected, setting a target movable object in the dynamic list according to the location information of the floating control signal or the location information of the interface control signal, obtaining a display location of the target movable object in the dynamic list, and locking the display location of the target movable object in the dynamic list.

### TECHNICAL FIELD

The present invention relates to the field of terminal device technologies, and in particular, to a method and an apparatus for locking an object in a list, and a terminal device.

### BACKGROUND

With rapid development of terminal device (such as a mobile phone, a computer, and a smartwatch) technologies, a terminal device becomes an indispensable tool in people's daily life. In a process of using the terminal device, people usually encounter a scenario in which a dynamic list (such as a selection list of wireless networks, a session list of a social application program, or a search list) includes a plurality of movable objects. A display location of each movable object is not unchangeable in the dynamic list. When receiving an update parameter or an update instruction, the terminal device adjusts each movable object in the dynamic list upwards or downwards. Therefore, for a same display location, different movable objects may be displayed at two moments: a moment before receiving of the update parameter or the update instruction and a moment after receiving of the update parameter or the update instruction. In this case, a user is likely to select a wrong movable object, thereby affecting user experience.

### SUMMARY

Embodiments of the present invention provide a method and an apparatus for locking an object in a list, and a terminal device, to lock a movable object required by a user, so that the user accurately enters a content display interface of the required movable object, thereby improving user experience.

A first aspect of the embodiments of the present invention provides a method for locking an object in a list, including:

determining whether a floating control signal entered for a dynamic list is detected within a preset vertical area of a display, where the dynamic list includes a plurality of movable objects whose display locations are changeable; obtaining location information of the floating control signal when the floating control signal is detected;

determining a target movable object in the dynamic list according to the location information of the floating control signal; and

obtaining a display location of the target movable object in the dynamic list, and locking the display location of the target movable object in the dynamic list.

According to the first aspect of the embodiments of the present invention, a movable object required by a user is locked by using a floating touch technology, so that the user accurately enters a content display interface of the required movable object, thereby improving user experience.

Based on the first aspect of the embodiments of the present invention, in a first possible implementation of the first aspect of the embodiments of the present invention, the location information of the floating control signal is obtained by determining whether a location of the floating control signal changes within a preset time period starting from a time when the floating control signal is detected, so as to determine the target movable object, that is, a to-be-locked movable object, in the dynamic list according to different types of location information, and this step is specifically:

if the location does not change, determining a stay location of the floating control signal as the location information of the floating control signal; or if the location changes, obtaining track information of a change of the location of the floating control signal, and determining the track information as the location information of the floating control signal.

Based on the first possible implementation of the first aspect of the embodiments of the present invention, in a second possible implementation of the first aspect of the embodiments of the present invention, the determining a target movable object in the dynamic list according to the location information of the floating control signal is specifically:

determining two movable objects as the target movable objects if a location of vertical projection of the stay location of the floating control signal on the display is in selection areas of the two movable objects; or

determining one movable object as the target movable object if a location of vertical projection of the stay location of the floating control signal on the display is in a selection area of the movable object.

Based on the first possible implementation of the first aspect of the embodiments of the present invention, in a third possible implementation of the first aspect of the embodiments of the present invention, the track information includes an initial location and a sliding direction, and the determining a target movable object in the dynamic list according to the location information of the floating control signal is: determining, as the target movable objects, all or a preset quantity of movable objects that are in the sliding direction and that start from a movable object corresponding to a location of vertical projection of the initial location on the display.

Based on the first possible implementation of the first aspect of the embodiments of the present invention, in a fourth possible implementation of the first aspect of the embodiments of the present invention, the track information includes a moving track, and the determining a target movable object in the dynamic list according to the location information of the floating control signal is: determining, as the target movable object, a movable object covered by an area of vertical projection of the moving track on the display.

Based on the first to the fourth possible implementations of the first aspect of the embodiments of the present invention, in a fifth possible implementation of the first aspect of the embodiments of the present invention, after the locking the display location of the target movable object in the dynamic list, the method further includes: unlocking the display location of the target movable object in the dynamic list if a slide operation that is entered for the dynamic list and that is in a preset direction is received.

Based on the first to the fourth possible implementations of the first aspect of the embodiments of the present invention, in a sixth possible implementation of the first aspect of the embodiments of the present invention, after the locking the display location of the target movable object in the dynamic list, the method further includes: unlocking the display location of the target movable object in the dynamic list if it is detected that duration of locking the display location of the target movable object in the dynamic list exceeds a preset threshold.

Based on the first to the fourth possible implementations of the first aspect of the embodiments of the present invention, in a seventh possible implementation of the first aspect of the embodiments of the present invention, after the locking the display location of the target movable object in the dynamic list, the method further includes: unlocking the display location of the target movable object in the dynamic list if an exit operation entered for the dynamic list is detected.

A second aspect of the embodiments of the present invention provides another method for locking an object in a list, including:

determining whether an interface control signal entered for a dynamic list is detected in a display interface of a display, where the dynamic list includes a plurality of movable objects whose display locations are changeable;

obtaining location information of the interface control signal when the interface control signal is detected;

determining a target movable object in the dynamic list according to the location information of the interface control signal; and

obtaining a display location of the target movable object in the dynamic list, and locking the display location of the target movable object in the dynamic list.

According to the second aspect of the embodiments of the present invention, a movable object required by a user is locked by tapping a plane or by using a touch technology, so that the user accurately enters a content display interface of the required movable object, thereby improving user experience.

Based on the second aspect of the embodiments of the present invention, in a first possible implementation of the second aspect of the embodiments of the present invention, the location information of the interface control signal is obtained by determining whether a location of the interface control signal changes within a preset time period starting from a time when the interface control signal is detected, so as to determine the target movable object, that is, a to-be-locked movable object, in the dynamic list according to different types of location information, and this step is specifically:

if the location does not change, determining a stay location of the interface control signal as the location information of the interface control signal; or if the location changes, obtaining track information of a change of the location of the interface control signal, and determining the track information as the location information of the interface control signal.

Based on the first possible implementation of the second aspect of the embodiments of the present invention, in a second possible implementation of the second aspect of the embodiments of the present invention, the determining a target movable object in the dynamic list according to the location information of the interface control signal is specifically:

determining two movable objects as the target movable objects if the stay location of the interface control signal is in selection areas of the two movable objects; or

determining one movable object as the target movable object if the stay location of the interface control signal is in a selection area of the movable object.

Based on the first possible implementation of the second aspect of the embodiments of the present invention, in a third possible implementation of the second aspect of the embodiments of the present invention, the track information includes a sliding track, and the determining a target movable object in the dynamic list according to the location information of the interface control signal is: determining, as the target movable object, a movable object through which the sliding track of the interface control signal passes.

Based on the first to the third possible implementations of the second aspect of the embodiments of the present invention, in a fourth possible implementation of the first aspect of the embodiments of the present invention, after the locking the display location of the target movable object in the dynamic list, the method further includes: unlocking the display location of the target movable object in the dynamic list if a slide operation that is entered for the dynamic list and that is in a preset direction is received.

Based on the first to the third possible implementations of the second aspect of the embodiments of the present invention, in a fifth possible implementation of the second aspect of the embodiments of the present invention, after the locking the display location of the target movable object in the dynamic list, the method further includes: unlocking the display location of the target movable object in the dynamic list if it is detected that duration of locking the display location of the target movable object in the dynamic list exceeds a preset threshold.

Based on the first to the third possible implementations of the second aspect of the embodiments of the present invention, in a sixth possible implementation of the second aspect of the embodiments of the present invention, after the locking the display location of the target movable object in the dynamic list, the method further includes: unlocking the display location of the target movable object in the dynamic list if an exit operation entered for the dynamic list is detected.

A third aspect of the embodiments of the present invention provides still another method for locking an object in a list, including:

determining whether a floating control signal entered for a dynamic list is detected within a preset vertical area of a display, where the floating control signal includes a plurality of movable objects whose display locations are changeable;

obtaining location information of the floating control signal when the floating control signal is detected;

determining a first movable object in the dynamic list and a display location of the first movable object in the dynamic list according to the location information of the floating control signal; and

if a select operation entered for a second movable object at the display location is detected within a preset time period starting from a time when the floating control signal is detected, outputting a dialog box including a selection list, where the selection list includes the first movable object and the second movable object.

According to the third aspect of the embodiments of the present invention, for a case in which different movable objects are displayed at a same display location, the selection list including the first movable object and the second movable object is output in a form of the dialog box by using a floating touch technology, so that a user determines to select which movable object, thereby improving user experience.

A fourth aspect of the embodiments of the present invention provides still another method for locking an object in a list, including:

determining whether an interface control signal entered for a dynamic list is detected in a display interface of a display, where the dynamic list includes a plurality of movable objects whose display locations are changeable;

obtaining location information of the interface control signal when the interface control signal is detected;

determining a first movable object in the dynamic list and a display location of the first movable object in the dynamic list according to the location information of the interface control signal; and

if a select operation entered for a second movable object at the display location is detected within a preset time period starting from a time when the interface control signal is detected, outputting a dialog box including a selection list, where the selection list includes the first movable object and the second movable object.

According to the fourth aspect of the embodiments of the present invention, for a case in which different movable objects are displayed at a same display location, the selection list including the first movable object and the second movable object is output in a form of the dialog box by tapping a plane or by using a touch technology, so that a user determines to select which movable object, thereby improving user experience.

A fifth aspect of the embodiments of the present invention provides an apparatus for locking an object in a list, including:

a signal detection unit, configured to determine whether a floating control signal entered for a dynamic list is detected within a preset vertical area of a display, where the dynamic list includes a plurality of movable objects whose display locations are changeable;

an information obtaining unit, configured to obtain location information of the floating control signal when the floating control signal is detected;

a target determining unit, configured to determine a target movable object in the dynamic list according to the location information of the floating control signal; and

a location locking unit, configured to obtain a display location of the target movable object in the dynamic list, and lock the display location of the target movable object in the dynamic list.

The apparatus for locking an object in a list that is provided in the fifth aspect of the embodiments of the present invention is configured to implement the method for locking an object in a list that is provided in the first aspect of the embodiments of the present invention, and details are not described herein again.

A sixth aspect of the embodiments of the present invention provides another apparatus for locking an object in a list, including:

a signal detection unit, configured to determine whether an interface control signal entered for a dynamic list is detected in a display interface of a display, where the dynamic list includes a plurality of movable objects whose display locations are changeable;

an information obtaining unit, configured to obtain location information of the interface control signal when the interface control signal is detected;

a target determining unit, configured to determine a target movable object in the dynamic list according to the location information of the interface control signal; and

a location locking unit, configured to obtain a display location of the target movable object in the dynamic list, and lock the display location of the target movable object in the dynamic list.

The apparatus for locking an object in a list that is provided in the sixth aspect of the embodiments of the present invention is configured to implement the method for locking an object in a list that is provided in the second aspect of the embodiments of the present invention, and details are not described herein again.

A seventh aspect of the embodiments of the present invention provides still another apparatus for locking an object in a list, including:

a signal detection unit, configured to determine whether a floating control signal entered for a dynamic list is detected within a preset vertical area of a display, where the floating control signal includes a plurality of movable objects whose display locations are changeable;

an information obtaining unit, configured to obtain location information of the floating control signal when the floating control signal is detected;

a location determining unit, configured to determine a first movable object in the dynamic list and a display location of the first movable object in the dynamic list according to the location information of the floating control signal; and

a dialog box output unit, configured to: if a select operation entered for a second movable object at the display location is detected within a preset time period starting from a time when the floating control signal is detected, output a dialog box including a selection list, where the selection list includes the first movable object and the second movable object.

The apparatus for locking an object in a list that is provided in the seventh aspect of the embodiments of the present invention is configured to implement the method for locking an object in a list that is provided in the third aspect of the embodiments of the present invention, and details are not described herein again.

An eighth aspect of the embodiments of the present invention provides still another apparatus for locking an object in a list, including:

a signal detection unit, configured to determine whether an interface control signal entered for a dynamic list is detected in a display interface of a display, where the dynamic list includes a plurality of movable objects whose display locations are changeable;

an information obtaining unit, configured to obtain location information of the interface control signal when the interface control signal is detected;

a location determining unit, configured to determine a first movable object in the dynamic list and a display location of the first movable object in the dynamic list according to the location information of the interface control signal; and

a dialog box output unit, configured to: if a select operation entered for a second movable object at the display location is detected within a preset time period starting from a time when the interface control signal is detected, output a dialog box including a selection list, where the selection list includes the first movable object and the second movable object.

The apparatus for locking an object in a list that is provided in the eighth aspect of the embodiments of the present invention is configured to implement the method for locking an object in a list that is provided in the fourth aspect of the embodiments of the present invention, and details are not described herein again.

A ninth aspect of the embodiments of the present invention provides still another apparatus for locking an object in a list, the apparatus for locking an object in a list includes an input module, an output module, a processor, a memory, and a sensor, the memory stores a group of program code, and the processor is configured to invoke the program code stored in the memory, so that the apparatus for locking an object in a list performs the method for locking an object in a list that is described in the first aspect of the embodiments of the present invention, the method for locking an object in a list that is described in the second aspect, the method for locking an object in a list that is described in the third aspect, or the method for locking an object in a list that is described in the fourth aspect.

A tenth aspect of the embodiments of the present invention provides a terminal device, including the apparatus for locking an object in a list that is described in the fourth aspect of the embodiments of the present invention, the apparatus for locking an object in a list that is described in the fifth aspect, the apparatus for locking an object in a list that is described in the sixth aspect, the apparatus for locking an object in a list that is described in the seventh aspect, the apparatus for locking an object in a list that is described in the eighth aspect, and the apparatus for locking an object in a list that is described in the ninth aspect.

In the embodiments of the present invention, whether the floating control signal entered for the dynamic list is detected within the preset vertical area of the display is determined, or whether the interface control signal entered for the dynamic list is detected in the display interface of the display is determined, and the dynamic list includes the plurality of movable objects whose display locations are changeable; the location information of the floating control signal or the location information of the interface control signal is obtained when the floating control signal or the interface control signal is detected; the target movable object is determined in the dynamic list according to the location information of the floating control signal or the location information of the interface control signal; and the display location of the target movable object in the dynamic list is obtained, and the display location of the target movable object in the dynamic list is locked. Therefore, a movable object required by a user is locked, so that the user accurately enters a content display interface of the required movable object, thereby improving user experience.

### BRIEF DESCRIPTION OF DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a hardware structure of a terminal device that implements an embodiment of the present invention;

FIG. 2 is a schematic flowchart of a method for locking an object in a list according to Embodiment 1 of the present invention;

FIG. 3 is a schematic flowchart of a method for locking an object in a list according to Embodiment 2 of the present invention;

FIG. 4 is a schematic diagram of selection areas of movable objects;

FIG. 5 is a schematic flowchart of a method for locking an object in a list according to Embodiment 3 of the present invention;

FIG. 6 is a schematic diagram of an interface of a dynamic list according to an embodiment of the present invention;

FIG. 7 is a schematic flowchart of a method for locking an object in a list according to Embodiment 4 of the present invention;

FIG. 8 is a schematic flowchart of a method for locking an object in a list according to Embodiment 5 of the present invention;

FIG. 9 is a schematic flowchart of a method for locking an object in a list according to Embodiment 6 of the present invention;

FIG. 10 is a schematic flowchart of a method for locking an object in a list according to Embodiment 7 of the present invention;

FIG. 11 is a schematic flowchart of a method for locking an object in a list according to Embodiment 8 of the present invention;

FIG. 12 is a schematic flowchart of a method for locking an object in a list according to Embodiment 9 of the present invention;

FIG. 13 is a schematic structural diagram of an apparatus for locking an object in a list according to an embodiment of the present invention;

FIG. 14 is a schematic structural diagram of another apparatus for locking an object in a list according to an embodiment of the present invention; and

FIG. 15 is a schematic structural diagram of still another apparatus for locking an object in a list according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

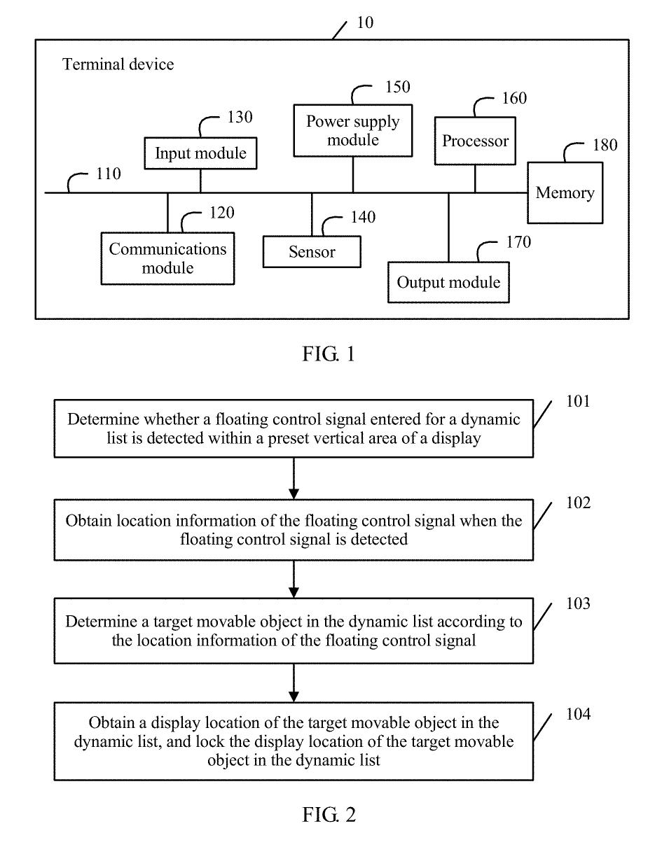

Referring to FIG. 1, FIG. 1 is a schematic diagram of a hardware structure of a terminal device that implements an embodiment of the present invention. The terminal device 10 may include a communications bus 110, a communications module 120, an input module 130, a sensor 140, a power supply module 150, a processor 160, an output module 170, a memory 180, and the like. The communications bus 110 is configured to implement connections and communication between these components. A person skilled in the art may understand that the hardware structure of the terminal device shown in FIG. 1 does not constitute a limitation on the present invention. The hardware structure may be a bus structure or a star structure, and may further include more or fewer components than those shown in FIG. 1, or combine some components, or have different component arrangements. In this embodiment of the present invention, the terminal device may be any mobile or portable electronic device, including but not limited to a mobile phone, a mobile computer, a tablet computer, a personal digital assistant (Personal Digital Assistant, PDA), a media player, a smart TV, a desktop computer, and a combination of the foregoing two or more items.

The input module 130 is configured to implement interaction between a user and the terminal device and/or enter information into the terminal device. For example, the input module 130 may receive digital or character information entered by the user, so as to generate signal input related to user setting or function control. In a possible implementation, the input module 130 may be a touch panel, or may be another human-computer interaction interface such as a substantive input key or a microphone, or may be another apparatus for obtaining external information, for example, a camera. The touch panel is also referred to as a touchscreen or a touchscreen, and may collect an operation action of touching or approaching performed by the user on the touch panel. For example, the user performs an operation action on the touch panel or at a location near the touch panel by using any appropriate object or accessory such as a finger or a stylus, and a corresponding connection apparatus is driven according to a preset program. Optionally, the touch panel may include two parts: a touch detection apparatus and a touch controller. The touch detection apparatus detects a touch operation of the user, converts the detected touch operation into an electrical signal, and transmits the electrical signal to the touch controller. The touch controller receives the electrical signal from the touch detection apparatus, converts the electrical signal into touch point coordinates, and then transmits the touch point coordinates to the processor 160. The touch controller may further receive and execute a command sent by the processor 160. In addition, the touch panel may be implemented in a plurality of types such as a resistive type, a capacitive type, an infrared (Infrared) ray type, and a surface acoustic wave type. In a possible implementation of the present invention, the substantive input key used by the input module 130 may include but is not limited to one or more of a physical keyboard, a function key (such as a volume control key or an on/off key), a trackball, a mouse, or a joystick. The input module 130 in a form of a microphone may collect a voice entered by the user or an environment, and convert the voice into a command that is in a form of an electrical signal and that can be executed by the processor 160.

The sensor 140 is a detection apparatus, can sense measured information, and can convert, for output, the sensed information into an electrical signal or information in another required form according to a specific rule, so as to meet requirements such as information transmission, processing, storage, display, record, and control. The sensor 130 may be various types of sensing components, for example, a Hall component, which is configured to detect a physical quantity of the terminal device, such as force, torque, pressure, stress, a location, displacement, a velocity, an acceleration, an angle, an angular velocity, a quantity of revolutions, a rotational velocity, and a time at which a working state changes, and convert the physical quantity into a quantity of electricity to perform detection and control. Some other sensing components may include a gravity sensor, a tri-axis accelerometer, a gyroscope, an electronic compass, an ambient light sensor, a proximity sensor, a temperature sensor, a humidity sensor, a pressure sensor, a heart rate sensor, a fingerprint sensor, and the like. In this embodiment of the present invention, for a mobile terminal device such as a mobile phone, a tablet computer, or a PDA, the sensor 130 further includes a self-capacitance sensor, which may implement a floating touch technology. That is, a touch operation entered by the user into the touch panel is detected when a finger of the user or a touch component is not in contact with the terminal device. For example, in winter, the user may use the touch panel through a thick glove, and even with obstruction of the glove, the sensor 130 can still detect a touch operation entered by the user. The self-capacitance sensor can generate a signal stronger than that generated by a mutual-capacitance sensor, and detect farther finger sensing, and a detection distance range may reach 20 mm.

The processor 160 is a control center of the terminal device, is connected to each part of the entire terminal device by using various interfaces and lines, and performs various functions of the terminal device and/or processes data by running or executing a software program and/or a module stored in the memory 180, and invoking data stored in the memory 180. The processor 160 may include an integrated circuit (Integrated Circuit, IC), for example, may include a single packaged IC, or may include a plurality of connected packaged ICs with a same function or different functions. For example, the processor 160 may include only a central processing unit (Central Processing Unit, CPU), or may be a combination of a graphics processing unit (Graphic Processing Unit, GPU), a digital signal processor (Digital Signal Processor, DSP), and a control chip (such as a baseband chip) in the communications module 120. In this implementation of the present invention, the CPU may be a single computing core, or may include a plurality of computing cores.

The communications module 120 is configured to establish a communications channel, so that the terminal device is connected to a remote server by using the communications channel, and downloads media data from the remote server. The communications module 120 may include a communications unit such as a wireless local area network (Wireless Local Area Network, wireless LAN) unit, a Bluetooth unit, or a baseband (Base Band, BB) unit, and a radio frequency (Radio Frequency, RF) circuit corresponding to the communications module 120, and is configured to perform wireless local area network communication, Bluetooth communication, infrared communication, and/or communication in a cellular communications system such as a Wideband Code Division Multiple Access (Wideband Code Division Multiple Access, W-CDMA) and/or High Speed Downlink Packet Access (High Speed Downlink Packet Access, HSDPA) system. The communications module 120 is configured to control communication between all the components in the terminal device, and may support direct memory access (Direct Memory Access, DMA).

In different implementations, each communications unit in the communications module 120 usually appears in a form of an integrated circuit chip (Integrated Circuit Chip, ICC), and may be selectively combined without a need of including all communications units and corresponding antenna groups. For example, the communications module 120 may include only a baseband chip, a radio frequency chip, and a corresponding antenna, so as to provide a communication function in the cellular communications system. The terminal device may be connected to a cellular network (Cellular Network, CN) or the Internet (Internet) by means of a wireless communications connection established by the communications module 120, for example, wireless local area network access or WCDMA access. In some optional implementations, the communications unit such as the baseband unit in the communications module 120 may be integrated into the processor 160, typically, such as an APQ+MDM family of platforms provided by Qualcomm (Qualcomm).

The radio frequency circuit is configured to: receive and send information, or receive and send a signal during a call; for example, after receiving downlink information from a base station, send the downlink information to the processor 160 for processing; and send uplink data to the base station. Generally, the radio frequency circuit includes a known circuit for performing these functions, including but not limited to an antenna system, a radio frequency transceiver, one or more amplifiers, a tuner, one or more oscillators, a digital signal processor, a codec (Codec) chip set, a subscriber identity module (SIM) card, and a memory. In addition, the radio frequency circuit may further communicate with a network and another device by means of wireless communication. Any communications standard or protocol may be used for the wireless communication, including but not limited to a Global System for Mobile Communications (Global System of Mobile communication, GSM), a general packet radio service (General Packet Radio Service, GPRS), Code Division Multiple Access (Code Division Multiple Access, CDMA), Wideband Code Division Multiple Access (Wideband Code Division Multiple Access, WCDMA), a High Speed Uplink Packet Access (High Speed Uplink Packet Access, HSUPA) technology, Long Term Evolution (Long Term Evolution, LTE), an email, and a short message service (Short Messaging Service, SMS).

The output module 170 includes but is not limited to an image output unit and a voice output unit. The image output unit is configured to output a text, a picture, and/or a video. The image output unit may include a display, for example, a display configured in a form of a liquid crystal display (Liquid Crystal Display, LCD), an organic light-emitting diode (Organic Light-Emitting Diode, OLED), or a field emission display (field emission display, FED). Alternatively, the image output unit may include a reflective display, for example, an electrophoretic (electrophoretic) display, or a display using an interferometric modulation of light (Interferometric Modulation of Light) technology. The image output unit may include a single display or a plurality of displays of different sizes. In a specific implementation of the present invention, the touch panel used by the input module 130 may be also used as a display of the output module 170. For example, after detecting a gesture operation of touching or approaching on the touch panel, the touch panel transmits the gesture operation to the processor 160 to determine a type of a touch event, and then the processor 160 provides corresponding visual output on the display according to the type of the touch event. In FIG. 1, although the input module 130 and the output module 170 are used as two independent parts to implement input and output functions of the electronic device, in some embodiments, the touch panel and the display may be integrated to implement the input and output functions of the electronic device. For example, the image output unit may display various graphical user interfaces (Graphical User Interface, GUI), and use the graphical user interfaces as virtual control components. The graphical user interfaces include but are not limited to a window, a scroll bar, an icon, and a clipboard, so that the user performs an operation in a touch manner.

In a specific implementation, the output module 170 includes a filter and an amplifier that are configured to filter and amplify a video output by the processor 160. An audio output unit includes a digital-to-analog converter that is configured to convert an audio signal output by the processor 160 from a digital format to an analog format. In this embodiment of the present invention, the output module 170 is configured to display a content display interface of a movable object, a dialog box, a dynamic list including a plurality of movable objects, and the like.

The memory 180 may be configured to store a software program and a module, and the processor 160 executes various functional applications of the electronic device and implements data processing by running the software program and the module that are stored in the memory 180. The memory 180 mainly includes a program storage area and a data storage area. The program storage area may store an operating system, and an application program required by at least one function, for example, a sound playing program or an image playing program. The data storage area may store data (such as audio data or a phone book) created according to use of the electronic device, and the like. In a specific implementation, the memory 180 may include a volatile memory such as a nonvolatile random access memory (Nonvolatile Random Access Memory, NVRAM), a phase change random access memory (Phase Change RAM, PRAM), or a magnetoresistive random access memory (Magetoresistive RAM, MRAM), or may include a nonvolatile memory such as at least one magnetic disk storage device, an electrically erasable programmable read-only memory (Electrically Erasable Programmable Read-Only Memory, EEPROM), or a flash memory device such as a NOR flash memory (NOR flash memory) or a NAND flash memory (NAND flash memory). The nonvolatile memory stores an operating system and an application program that are executed by the processor 160. The processor 160 loads, from the nonvolatile memory, a running program and data to a memory, and stores digital content in a mass storage apparatus. The operating system includes various components and/or drivers that are configured to control and manage a routine system task, for example, memory management, storage device control, and power management, and that facilitate communication between various types of software and hardware. In an implementation of the present invention, the operating system may be an Android system of Google, an iOS system developed by Apple, a Windows operating system developed by Microsoft, or an embedded operating system such as VxWorks.

The application program includes any application installed on the electronic device, and includes but is not limited to a browser, an email, an instant messaging service, word processing, keyboard virtualization, a window widget (Widget), encryption, digital copyright management, voice recognition, voice duplication, positioning (such as a function provided by a Global Positioning System), and music play.

The power supply module 150 is configured to supply power to different parts of the terminal device to maintain running of the parts. Generally, the power supply module 150 may be a built-in battery such as a common lithium-ion battery or a nickel-hydride battery, or may include an external power supply that directly supplies power to the electronic device, for example, an AC adapter. In some implementations, the power supply may be further defined in a wider scope, for example, may further include a power management system, a charging system, a power failure detection circuit, a power converter or inverter, a power status indicator (such as a light emitting diode), and any other components related to power generation, management, and distribution of the electronic device.

A method and an apparatus for locking an object in a list, and a terminal device that are provided in the embodiments of the present invention may be applied to a scenario of locking a display location of a movable object or display locations of several movable objects in a dynamic list. The dynamic list is a list including a plurality of movable objects, and may include a selection list of wireless networks, a session list of a social application program, a search list, or the like. The apparatus for locking an object in a list in the embodiments of the present invention may be used as an independent apparatus, or may be integrated into various different terminal devices such as a mobile phone, a mobile computer, a tablet computer, a PDA, a media player, a smart TV, or a desktop computer.

A method for locking an object in a list that is provided in embodiments of the present invention is described below in detail with reference to FIG. 1 to FIG. 7.

Referring to FIG. 2, FIG. 2 is a schematic flowchart of a method for locking an object in a list according to Embodiment 1 of the present invention. With reference to the terminal device shown in FIG. 1, the memory 180 stores a group of program code, and the processor 160 invokes the program code stored in the memory 180, to perform the method for locking an object in a list. The method may include the following step 101 to step 104.

101. Determine whether a floating control signal entered for a dynamic list is detected within a preset vertical area of a display.

Specifically, the display of the output module 170 of the terminal device 10 may present various types of image information to a user, for example, information such as a video, a photograph, a text, and a list. If the dynamic list is in a display interface of the display, and the dynamic list includes a plurality of movable objects whose display locations are changeable, the processor 160 determines, by using the sensor 140, whether the floating control signal entered for the dynamic list is detected within the preset vertical area of the display. The dynamic list may include but is not limited to a selection list of wireless networks, a session list of a social application program, or a search list. The display locations that are in the dynamic list and that are of the plurality of movable objects included in the dynamic list are not unchangeable, and the plurality of movable objects may move upwards or downwards in terms of display locations according to some update parameters or update instructions. In addition, the plurality of movable objects included in the dynamic list are different at different moments.

During running of the terminal device 10, the sensor 140 detects, in real time, whether there is an air gesture within the preset vertical area of the display. The air gesture may be entered by the user by using a finger or a touch component. However, in this input process, the finger or the touch component is not directly in contact with the display. In a process of detecting the air gesture, the sensor 140 can further identify a touch operation of the air gesture. The sensor 140 converts the air gesture or the touch operation of the air gesture into an electrical signal, and transfers the electrical signal to the processor 160. The processor 160 controls implementation of a corresponding function. In this embodiment of the present invention, when the dynamic list is in the display interface of the display, if the sensor 140 detects that there is an air gesture entered by the user, the sensor 140 generates a floating control signal according to the air gesture, and transfers the floating control signal to the processor 160. The processor 160 determines that the sensor 140 detects the floating control signal. The preset vertical area of the display is an area that is at a preset distance from the display and that is in a direction perpendicular to the display. A specific value of the preset distance is determined by the sensor 140 used by the terminal device 10. For example, a detection distance of a self-capacitance sensor may reach 20 mm. Then, the preset distance is 20 mm.

102. Obtain location information of the floating control signal when the floating control signal is detected.

Specifically, because the floating control signal is entered by using the finger of the user or the touch component, a floating location that is of the floating control signal and within the preset vertical area of the display is controlled by the user, and may remain unchanged or may change. Therefore, if the sensor 140 detects that the floating control signal exists within the preset vertical area of the display, the processor 160 obtains the location information of the floating control signal by using the sensor 140. The location information of the floating control signal, that is, floating location information of the floating control signal within the preset vertical area, is also floating location information of the air gesture. The location information of the floating control signal is used to indicate whether the floating location of the floating control signal changes, and indicate a change status.

The processor 160 determines whether the location of the floating control signal changes within a preset time period starting from a time when the floating control signal is detected, that is, determines whether a floating location of the air gesture changes within the preset time period. If the location does not change, it may be understood that the air gesture is suspended and stays at a location above the display in a vertical direction without moving, and the processor 160 determines a stay location of the floating control signal as the location information of the floating control signal. Because the air gesture stays at the location without moving within the preset time period, the stay location of the floating control signal is a floating location at which the air gesture remains still. If the location changes, the processor 160 obtains track information of a change of the location of the floating control signal, and determines the track information as the location information of the floating control signal. The track information includes an initial location and a sliding direction, or includes a moving track. A specific value of the preset time period is set by a manufacturer of the terminal device 10. The specific value is not limited herein.

103. Determine a target movable object in the dynamic list according to the location information of the floating control signal.

Specifically, the processor 160 determines the target movable object in the dynamic list according to the location information of the floating control signal. There may be one, two, or more target movable objects. This is determined according to the location information of the floating control signal.

104. Obtain a display location of the target movable object in the dynamic list, and lock the display location of the target movable object in the dynamic list.

Specifically, the processor 160 obtains the display location of the target movable object in the dynamic list, and locks the display location of the target movable object in the dynamic list, that is, keeps, unchanged, a relative display relationship between the display and the display location of the target movable object in the dynamic list, or keeps, unchanged, a display sequence of the display location of the target movable object in the dynamic list. If an update instruction or an update parameter for the dynamic list is received, the display location of the target movable object in the dynamic list does not change due to the update instruction or the update parameter. For example, the display location of the target object in the dynamic list is a second display location. If an update instruction for the target object is received, the processor 160 shields or refuses a part that is in the update instruction and that is for updating the display location, receives only update content (such as SMS message content or a chat message) in the update instruction, and keeps the display location of the target object in the dynamic list unchanged, that is, the second display location. If an update instruction for a movable object at a third display location in the dynamic list is received, the movable object originally at the third display location switches over to a first display location, a movable object originally at the first display location switches over to the third display location, and the display location of the target object in the dynamic list remains the second display location.

If there is more than one target movable object, a display location of each target movable object in the dynamic list is obtained, and the display location of each target movable object in the dynamic list is locked. Locking the display location of the target movable object may effectively prevent mistaken selection of the user after the display locations of the plurality of movable objects in the dynamic list change, so that the user accurately selects a required movable object.

After step 104, if the input module 130 receives a select operation entered for any movable object in the dynamic list, the processor 160 controls the output module 170 to display a content display interface of the movable object corresponding to the select operation. That is, in this case, the processor 160 controls the output module 170 to jump from the dynamic list on a current display interface to the content display interface of the movable object corresponding to the select operation, for example, an interface of entering a password of a wireless network or an interface of a conversation. The select operation may be a tap operation or a touch and hold operation, and is not limited herein. The any movable object may be the target movable object, or may be any movable object other than the target movable object.

In this embodiment of the present invention, whether the floating control signal entered for the dynamic list is detected within the preset vertical area of the display is determined, and the dynamic list includes the plurality of movable objects whose display locations are changeable; the location information of the floating control signal is obtained when the floating control signal is detected; the target movable object is determined in the dynamic list according to the location information of the floating control signal; and the display location of the target movable object in the dynamic list is obtained, and the display location of the target movable object in the dynamic list is locked. Therefore, a movable object that is required by a user and that is in a dynamic list is locked by using a floating control signal, so that the user accurately enters a content display interface of the required movable object, thereby improving user experience.

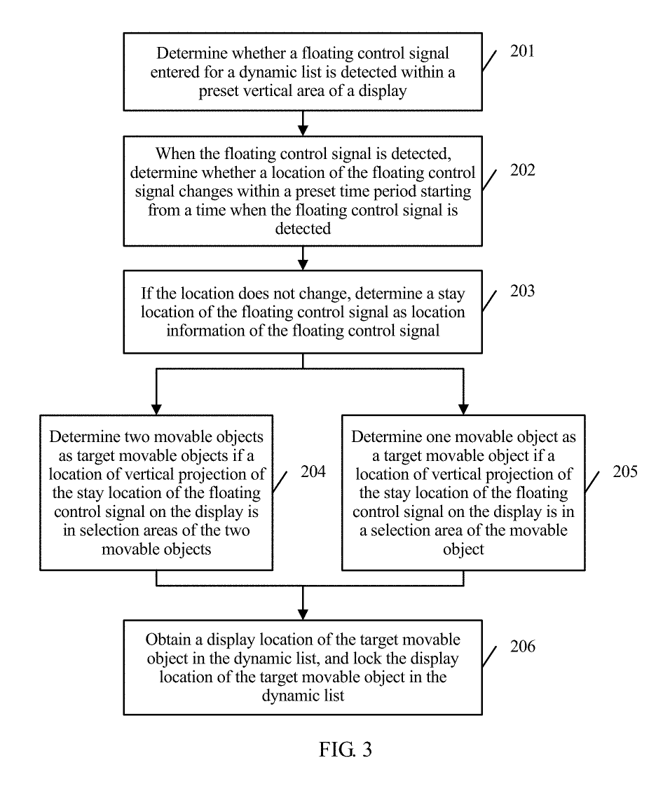

Referring to FIG. 3, FIG. 3 is a schematic flowchart of a method for locking an object in a list according to Embodiment 2 of the present invention. With reference to the terminal device shown in FIG. 1, the memory 180 stores a group of program code, and the processor 160 invokes the program code stored in the memory 180, to perform the method for locking an object in a list. The method may include the following step 201 to step 206.

201. Determine whether a floating control signal entered for a dynamic list is detected within a preset vertical area of a display.

For a specific implementation process of step 201 in this embodiment of the present invention, refer to a specific description about step 101 in Embodiment 1 shown in FIG. 2 of the present invention, and details are not described herein again.

202. When the floating control signal is detected, determine whether a location of the floating control signal changes within a preset time period starting from a time when the floating control signal is detected.

Specifically, because the floating control signal is entered by using the finger of the user or the touch component, a floating location that is of the floating control signal and within the preset vertical area of the display is controlled by the user, and may remain unchanged or may change. Therefore, if the sensor 140 detects that the floating control signal exists within the preset vertical area of the display, the processor 160 obtains location information of the floating control signal by using the sensor 140. The location information of the floating control signal, that is, floating location information of the floating control signal within the preset vertical area, is also floating location information of the air gesture. The location information of the floating control signal is used to indicate whether the floating location of the floating control signal changes, and indicate a change status.

The processor 160 determines, by using the sensor 140, whether the location of the floating control signal changes within the preset time period starting from the time when the floating control signal is detected, so as to obtain the location information of the floating control signal. When starting to detect the floating control signal, the sensor 140 obtains an initial location of the floating control signal, detects, within the preset time period in real time, whether the floating control signal deviates from the initial location, and sends a detection result to the processor 160. A specific value of the preset time period is set by a manufacturer of the terminal device 10. The specific value is not limited herein.

203. If the location does not change, determine a stay location of the floating control signal as location information of the floating control signal.

Specifically, if the location does not change, it may be understood that the floating control signal is suspended and stays at a location above the display in a vertical direction without moving, that is, vertical projection of a floating location of the air gesture on the display remains unchanged at a location, and the processor 160 controls the sensor 140 to obtain the stay location of the floating control signal by using a floating touch technology, and determines the stay location of the floating control signal as the location information of the floating control signal. The stay location of the floating control signal is a floating location at which the air gesture remains still.

204. Determine two movable objects as target movable objects if a location of vertical projection of the stay location of the floating control signal on the display is in selection areas of the two movable objects.

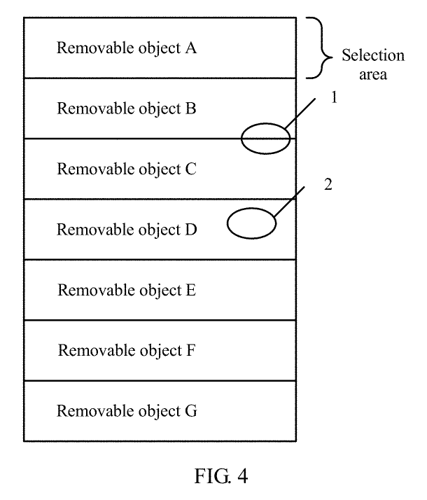

Specifically, a location of vertical projection of the stay location of the air gesture on the display is in the selection areas of the two movable objects, that is, the location of the vertical projection of the stay location of the air gesture on the display is in both the selection areas of the two movable objects. As shown in FIG. 4, FIG. 4 is a schematic diagram of selection areas of movable objects. Ellipses 1 and 2 in FIG. 4 indicate vertical projection of the floating control signal on the display. The ellipse 1 is located at a selection area of a movable object B and a selection area of a movable object C. In this case, it is not easy to determine a specific movable object above which the floating control signal stays. Therefore, the processor 160 determines the two movable objects as the target movable objects, that is, determines the movable object B and the movable object C as the target movable objects.

205. Determine one movable object as the target movable object if a location of vertical projection of the stay location of the floating control signal on the display is in a selection area of the movable object.

Specifically, if the location of the vertical projection of the stay location of the floating control signal on the display is in the selection area of the movable object, that is, if a location of vertical projection of a stay location of the air gesture on the display is in the selection area of the movable object, a specific movable object above which the air gesture stays may be determined. Therefore, the processor 160 determines the movable object as the target movable object. For a selection area of a movable object, refer to a selection area marked in FIG. 4. It may be understood that the user enters a tap operation into the selection area, and the processor 160 may be triggered, so as to jump to a content display interface of the movable object. For example, the ellipse 2 in FIG. 4 is located at a selection area of a movable object D, and the processor 160 determines the movable object D as the target movable object.

206. Obtain a display location of the target movable object in the dynamic list, and lock the display location of the target movable object in the dynamic list.

Specifically, if the target movable objects are the two movable objects, the processor 160 obtains a display location of each of the two movable objects in the dynamic list, and locks the display location of each movable object in the dynamic list, that is, keeps, unchanged, a relative display relationship between each movable object and the display, or keeps, unchanged, a display sequence of the display locations of the target movable objects in the dynamic list. For example, for a dynamic list including five wireless networks, the vertical projection of the stay location of the air gesture on the display is located at selection areas of a second wireless network and a third wireless network. The processor 160 obtains display locations of the second wireless network and the third wireless network in the dynamic list, and locks the display locations of the second wireless network and the third wireless network in the dynamic list. Remaining three wireless networks may move upwards or downwards in terms of locations as signal strength changes. However, the display locations of the second wireless network and the third wireless network do not change.

If the target movable object is the movable object, the processor 160 obtains a display location of the movable object in the dynamic list, and locks the display location of the movable object in the dynamic list, that is, keeps, unchanged, a relative display relationship between the movable object and the display, or keeps, unchanged, a display sequence of the display location of the movable object in the dynamic list. For example, a session list of a social application program includes six conversations. If the vertical projection of the stay location of the floating control signal on the display is located at a selection area of a third conversation, the processor 160 obtains a display location of the third conversation in the session list, and keeps, unchanged, a relative display relationship between the display location and the display. Even if a new message for the third conversation is received, the display location of the third conversation in the session list does not change.

After step 206, if the input module 130 receives a select operation entered for any movable object in the dynamic list, the processor 160 controls the output module 170 to display a content display interface of the movable object corresponding to the select operation. That is, in this case, the processor 160 controls the output module 170 to jump from the dynamic list on a current display interface to the content display interface of the movable object corresponding to the select operation, for example, an interface of entering a password of a wireless network or an interface of a conversation. The select operation may be a tap operation or a touch and hold operation, and is not limited herein. The any movable object may be the target movable object, or may be any movable object other than the target movable object.

In this embodiment of the present invention, whether the floating control signal entered for the dynamic list is detected within the preset vertical area of the display is determined, and the dynamic list includes the plurality of movable objects whose display locations are changeable; when the floating control signal is detected, whether the location of the floating control signal changes within the preset time period starting from the time when the floating control signal is detected is determined; if the location does not change, the target movable object is determined according to the location information of the floating control signal; and the display location of the target movable object in the dynamic list is obtained, and the display location of the target movable object in the dynamic list is locked. Therefore, a movable object required by a user is locked by using a floating touch technology, so that the user accurately enters a content display interface of the required movable object, thereby improving user experience.

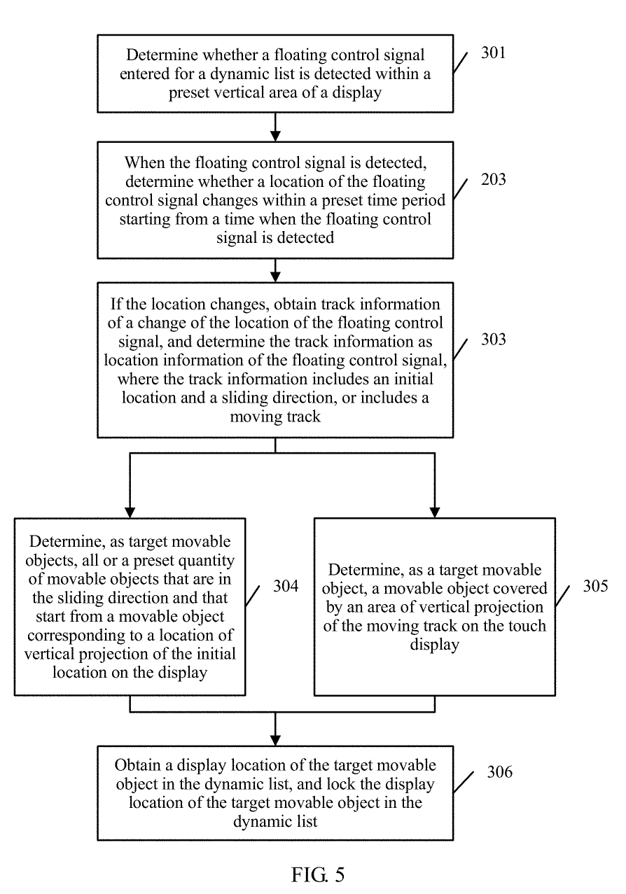

Referring to FIG. 5, FIG. 5 is a schematic flowchart of a method for locking an object in a list according to Embodiment 3 of the present invention. With reference to the terminal device shown in FIG. 1, the memory 180 stores a group of program code, and the processor 160 invokes the program code stored in the memory 180, to perform the method for locking an object in a list. The method may include the following step 301 to step 306.

301. Determine whether a floating control signal entered for a dynamic list is detected within a preset vertical area of a display.

302. When the floating control signal is detected, determine whether a location of the floating control signal changes within a preset time period starting from a time when the floating control signal is detected.

For specific implementation processes of step 301 and step 302 in this embodiment of the present invention, refer to specific descriptions about step 201 and step 202 in Embodiment 2 shown in FIG. 3 of the present invention, and details are not described herein again.

303. If the location changes, obtain track information of a change of the location of the floating control signal, and determine the track information as location information of the floating control signal, where the track information includes an initial location and a sliding direction, or includes a moving track.

Specifically, if the location changes, it may be understood that the floating control signal does not stay at a location above the display in a vertical direction without moving, but changes. Therefore, the processor 160 controls the sensor 140 to obtain the track information of the change of the location of the floating control signal, that is, track information of a change of a location of the air gesture, by using a floating touch technology. The track information may be an upward sliding direction or a downward sliding direction, or may be a track in a shape of a regular closed figure or an irregular closed figure. Therefore, if the track information is the upward sliding direction or the downward sliding direction, the track information includes an initial location of the air gesture and a sliding direction of the air gesture. If the track information is the track in a shape of a regular closed figure or an irregular closed figure, the track information includes a moving track of the air gesture.

304. Determine, as target movable objects, all or a preset quantity of movable objects that are in the sliding direction and that start from a movable object corresponding to a location of vertical projection of the initial location on the display.

Specifically, when the track information includes the initial location and the sliding direction, the processor 160 determines, by using the sensor 140, a movable object corresponding to a location of vertical projection of the initial location of the air gesture on the display, that is, the movable object corresponding to the location of the vertical projection on the display.

Optionally, the processor 160 determines, as target movable objects, all movable objects that are in the sliding direction and that start from the movable object. For example, for a dynamic list including five wireless networks, if the initial location of the air gesture is corresponding to a second wireless network, and the sliding direction of the air gesture is a downward direction, the processor determines the second wireless network, a third wireless network, a fourth wireless network, and a fifth wireless network as target movable objects, or determines a third wireless network, a fourth wireless network, and a fifth wireless network as target movable objects.

Optionally, the processor 160 determines, as target movable objects, a preset quantity of movable objects that are in the sliding direction and that start from the movable object. For example, for a dynamic list including five wireless networks, if the initial location of the air gesture is corresponding to a second wireless network, the sliding direction of the air gesture is a downward direction, and the preset quantity is two, the processor determines the second wireless network and a third wireless network as target movable objects, or determines a third wireless network and a fourth wireless network as target movable objects. The preset quantity is set by a manufacturer of the terminal device 10 or is autonomously set by a user, and a specific value is not limited herein.

305. Determine, as a target movable object, a movable object covered by an area of vertical projection of the moving track on the touch display.

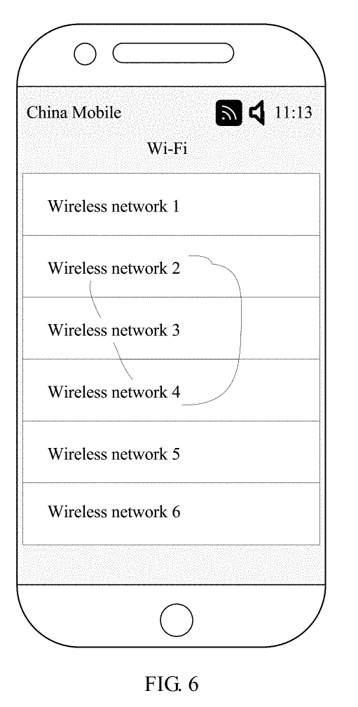

Specifically, when the track information includes the moving track, the processor 160 determines, as the target movable object by using the sensor 140, the movable object covered by the area of the vertical projection of the moving track on the display. Referring to FIG. 6, FIG. 6 is a schematic diagram of an interface of a dynamic list. An irregular figure in FIG. 6 is vertical projection of the air gesture on the display. Movable objects covered by an area of the vertical projection are a wireless network 2, a wireless network 3, and a wireless network 4. The processor 160 determines the three movable objects as target movable objects. It should be noted that, a selection list of wireless networks is used as an example in FIG. 6, a movable object included in another dynamic list depends on a specific case, and other content in the display interface is not limited in this embodiment of the present invention. Some actually existing content is not marked in FIG. 6, for example, signal strength and a password identifier of each wireless network.

306. Obtain a display location of the target movable object in the dynamic list, and lock the display location of the target movable object in the dynamic list.

Specifically, if the target movable objects are the two movable objects, the processor 160 obtains a display location of each of the two movable objects in the dynamic list, and locks the display location of each movable object in the dynamic list, that is, keeps, unchanged, a relative display relationship between each movable object and the display, or keeps, unchanged, a display sequence of the display locations of the target movable objects in the dynamic list. For example, the target movable objects determined in FIG. 6 are the wireless network 2, the wireless network 3, and the wireless network 4. If an update parameter for the wireless network 2 is received, the processor 160 updates only signal strength of the wireless network 2 according to the update parameter, but does not change a display location of the wireless network 2 in FIG. 6. If an update parameter for a wireless network 5 is received, the processor 160 adjusts a display location of the wireless network 5 in FIG. 6, but does not change display locations of the wireless network 2, the wireless network 3, and the wireless network 4 in FIG. 6.

After step 306, if the input module 130 receives a select operation entered for any movable object in the dynamic list, the processor 160 controls the output module 170 to display a content display interface of the movable object corresponding to the select operation. That is, in this case, the processor 160 controls the output module 170 to jump from the dynamic list on a current display interface to the content display interface of the movable object corresponding to the select operation, for example, an interface of entering a password of a wireless network or an interface of a conversation. The select operation may be a tap operation or a touch and hold operation, and is not limited herein. The any movable object may be the target movable object, or may be any movable object other than the target movable object.

In this embodiment of the present invention, whether the floating control signal entered for the dynamic list is detected within the preset vertical area of the display is determined, and the dynamic list includes the plurality of movable objects whose display locations are changeable; when the floating control signal is detected, whether the location of the floating control signal changes within the preset time period starting from the time when the floating control signal is detected is determined; if the location changes, the target movable object is determined according to a change status of the location of the floating control signal; and the display location of the target movable object in the dynamic list is obtained, and the display location of the target movable object in the dynamic list is locked. Therefore, a movable object required by a user is locked by using a floating touch technology, so that the user accurately enters a content display interface of the required movable object, thereby improving user experience.

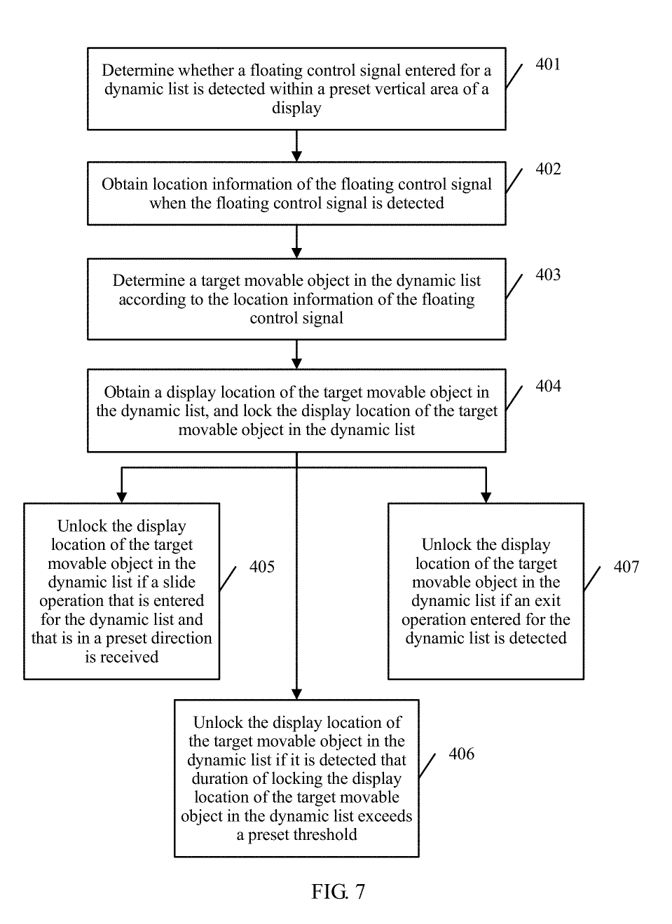

Referring to FIG. 7, FIG. 7 is a schematic flowchart of a method for locking an object in a list according to Embodiment 4 of the present invention. With reference to the terminal device shown in FIG. 1, the memory 180 stores a group of program code, and the processor 160 invokes the program code stored in the memory 180, to perform the method for locking an object in a list. The method may include the following step 401 to step 407.

401. Determine whether a floating control signal entered for a dynamic list is detected within a preset vertical area of a display.

402. Obtain location information of the floating control signal when the floating control signal is detected.

403. Determine a target movable object in the dynamic list according to the location information of the floating control signal.

404. Obtain a display location of the target movable object in the dynamic list, and lock the display location of the target movable object in the dynamic list.

For specific implementation processes of step 401 to step 404 in this embodiment of the present invention, refer to specific descriptions about step 101 to step 104 in Embodiment 1 shown in FIG. 2 of the present invention, and details are not described herein again.

405. Unlock the display location of the target movable object in the dynamic list if a slide operation that is entered for the dynamic list and that is in a preset direction is received.

Specifically, if the input module 130 receives the slide operation that is entered for the dynamic list and that is in the preset direction, the processor 160 unlocks the display location of the target movable object in the dynamic list. In this case, the target movable object may be adjusted as another movable object is adjusted. The preset direction may be a leftward direction or a rightward direction, or may be a direction autonomously set by the user for unlocking. This is not limited herein.

406. Unlock the display location of the target movable object in the dynamic list if it is detected that duration of locking the display location of the target movable object in the dynamic list exceeds a preset threshold.

Specifically, if the input module 130 detects that the duration of locking the display location of the target movable object in the dynamic list exceeds the preset threshold, the processor 160 unlocks the display location of the target movable object in the dynamic list. In this case, the target movable object may be adjusted as another movable object is adjusted. The preset threshold may be set by a manufacturer of the terminal device 10, or the user may autonomously set the duration threshold.

407. Unlock the display location of the target movable object in the dynamic list if an exit operation entered for the dynamic list is detected.

Specifically, if the input module 130 detects, by using the sensor 140, the exit operation entered for the dynamic list, that is, if the user exits from a current display interface, the processor 160 unlocks the display location of the target movable object in the dynamic list.

In this embodiment of the present invention, after the display location of the target movable object in the dynamic list is locked, the target movable object may be unlocked according to an operation entered by the user, to restore the target movable object to an initial status, so that the user enters another operation.

It should be noted that, step 405, step 406, and step 407 are three parallel steps, and only one of the steps needs to be performed. Step 405, step 406, and step 407 may be performed after step 206 is performed in Embodiment 2, or may be performed after step 306 is performed in Embodiment 3.

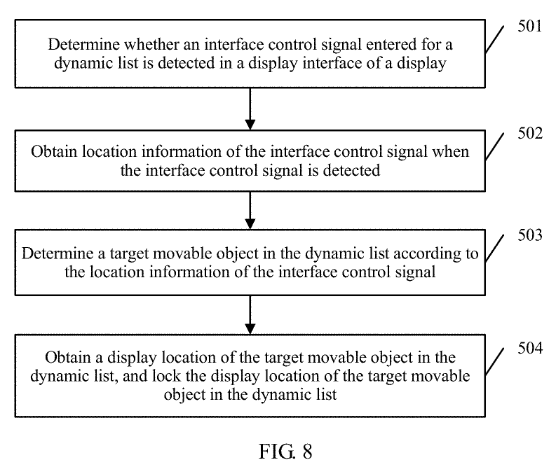

Referring to FIG. 8, FIG. 8 is a schematic flowchart of a method for locking an object in a list according to Embodiment 5 of the present invention. With reference to the terminal device shown in FIG. 1, the memory 180 stores a group of program code, and the processor 160 invokes the program code stored in the memory 180, to perform the method for locking an object in a list. The method may include the following step 501 to step 504.

501. Determine whether an interface control signal entered for a dynamic list is detected in a display interface of a display.

Specifically, the display of the output module 170 of the terminal device 10 may present various types of image information to a user, for example, information such as a video, a photograph, a text, and a list. If the dynamic list is in the display interface of the display, and the dynamic list includes a plurality of movable objects whose display locations are changeable, the processor 160 determines, by using the sensor 140, whether the interface control signal entered for the dynamic list is detected in the display interface of the display, or the processor 160 controls the input module 130 to determine whether the interface control signal entered for the dynamic list is detected in the display interface of the display. The dynamic list may include but is not limited to a selection list of wireless networks, a session list of a social application program, or a search list. The display locations that are in the dynamic list and that are of the plurality of movable objects included in the dynamic list are not unchangeable, and the plurality of movable objects may move upwards or downwards in terms of display locations according to some update parameters or update instructions. In addition, the plurality of movable objects included in the dynamic list are different at different moments.

The interface control signal may be a mobile cursor signal entered by the user by using an input device such as a mouse, and may be displayed in the display interface of the display. Alternatively, the interface control signal may be a touch signal entered by the user by using a finger or a touch component to be directly in contact with the display, and may be displayed in the display interface of the display, or may not be displayed.

502. Obtain location information of the interface control signal when the interface control signal is detected.

Specifically, because the interface control signal is entered by the user, a display location of the interface control signal on the display is controlled by the user, and may remain unchanged or may change. Therefore, if the sensor 140 or the input module 130 detects that the interface control signal exists in the display interface of the display, the processor 160 obtains the location information of the interface control signal by using the sensor 140, or controls the input module 130 to obtain the location information of the interface control signal.

503. Determine a target movable object in the dynamic list according to the location information of the interface control signal.

Specifically, the processor 160 determines the target movable object in the dynamic list according to the location information of the interface control signal. There may be one, two, or more target movable objects. This is determined according to the location information of the interface control signal.

504. Obtain a display location of the target movable object in the dynamic list, and lock the display location of the target movable object in the dynamic list.

Specifically, the processor 160 obtains the display location of the target movable object in the dynamic list, and locks the display location of the target movable object in the dynamic list, that is, keeps, unchanged, a relative display relationship between the display and the display location of the target movable object in the dynamic list, or keeps, unchanged, a display sequence of the display location of the target movable object in the dynamic list. If an update instruction or an update parameter for the dynamic list is received, the display location of the target movable object in the dynamic list does not change due to the update instruction or the update parameter. For example, the display location of the target object in the dynamic list is a second display location. If an update instruction for the target object is received, the processor 160 shields or refuses a part that is in the update instruction and that is for updating the display location, receives only update content (such as SMS message content or a chat message) in the update instruction, and keeps the display location of the target object in the dynamic list unchanged, that is, the second display location. If an update instruction for a movable object at a third display location in the dynamic list is received, the movable object originally at the third display location switches over to a first display location, a movable object originally at the first display location switches over to the third display location, and the display location of the target object in the dynamic list remains the second display location.

If there is more than one target movable object, a display location of each target movable object in the dynamic list is obtained, and the display location of each target movable object in the dynamic list is locked. Locking the display location of the target movable object may effectively prevent mistaken selection of the user after the display locations of the plurality of movable objects in the dynamic list change, so that the user accurately selects a required movable object.

After step 504, if the input module 130 receives a select operation entered for any movable object in the dynamic list, the processor 160 controls the output module 170 to display a content display interface of the movable object corresponding to the select operation. That is, in this case, the processor 160 controls the output module 170 to jump from the dynamic list on a current display interface to the content display interface of the movable object corresponding to the select operation, for example, an interface of entering a password of a wireless network or an interface of a conversation. The select operation may be a click or tap operation, or a touch and hold operation, and is not limited herein. The any movable object may be the target movable object, or may be any movable object other than the target movable object.

In this embodiment of the present invention, whether the interface control signal entered for the dynamic list is detected in the display interface of the display is determined, and the dynamic list includes the plurality of movable objects whose display locations are changeable; the location information of the interface control signal is obtained when the interface control signal is detected; the target movable object is determined in the dynamic list according to the location information of the interface control signal; and the display location of the target movable object in the dynamic list is obtained, and the display location of the target movable object in the dynamic list is locked. Therefore, a movable object required by a user is locked, so that the user accurately enters a content display interface of the required movable object, thereby improving user experience.

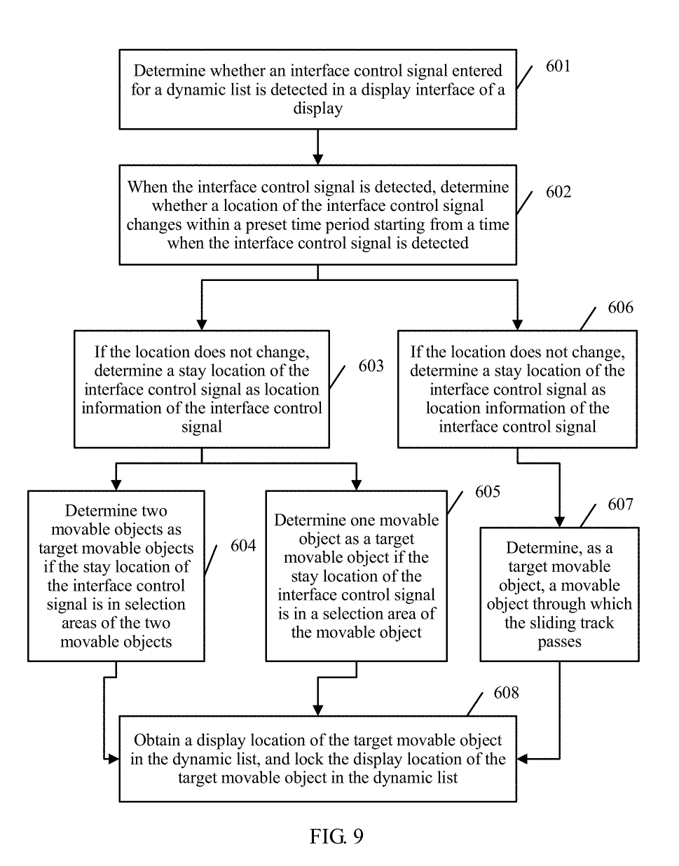

Referring to FIG. 9, FIG. 9 is a schematic flowchart of a method for locking an object in a list according to Embodiment 6 of the present invention. With reference to the terminal device shown in FIG. 1, the memory 180 stores a group of program code, and the processor 160 invokes the program code stored in the memory 180, to perform the method for locking an object in a list. The method may include the following step 601 to step 608.

601. Determine whether an interface control signal entered for a dynamic list is detected in a display interface of a display, where the dynamic list includes a plurality of movable objects whose display locations are changeable.

For a specific implementation process of step 601 in this embodiment of the present invention, refer to a specific description about step 501 in Embodiment 5 shown in FIG. 8 of the present invention, and details are not described herein again.

602. When the interface control signal is detected, determine whether a location of the interface control signal changes within a preset time period starting from a time when the interface control signal is detected.

Specifically, because the interface control signal is entered by the user, a display location of the interface control signal on the display is controlled by the user, and may remain unchanged or may change. Therefore, if the sensor 140 or the input module 130 detects that the interface control signal exists in the display interface of the display, the processor 160 obtains location information of the interface control signal by using the sensor 140, or controls the input module 130 to obtain location information of the interface control signal.

The processor 160 determines, by using the sensor 140 or the input module 130, whether the location of the interface control signal changes within the preset time period starting from the time when the interface control signal is detected, so as to obtain the location information of the interface control signal. When starting to detect the interface control signal, the sensor 140 or the input module 130 obtains an initial location of the interface control signal, detects, within the preset time period in real time, whether the interface control signal deviates from the initial location, and sends a detection result to the processor 160. A specific value of the preset time period is set by a manufacturer of the terminal device 10. The specific value is not limited herein.

603. If the location does not change, determine a stay location of the interface control signal as location information of the interface control signal.

Specifically, if the location of the interface control signal does not change within the preset time period, that is, the interface control signal stays at a location in the display interface, the processor 160 controls the sensor 140 or the input module 130 to obtain the stay location of the interface control signal.

604. Determine two movable objects as target movable objects if the stay location of the interface control signal is in selection areas of the two movable objects.

Specifically, if the stay location of the interface control signal is in the selection areas of the two movable objects, it is not easy to determine a movable object which the interface control signal is specific to. Therefore, the processor 160 determines the two movable objects as the target movable objects.

605. Determine one movable object as the target movable object if the stay location of the interface control signal is in a selection area of the movable object.

Specifically, if the stay location of the interface control signal is in the selection area of the movable object, a movable object which the interface control signal is specific to may be determined. Therefore, the processor 160 determines the movable object as the target movable object. For a selection area of a movable object, it may be understood that the user enters a click or tap operation into the selection area, and the processor 160 may be triggered, so as to jump to a content display interface of the movable object.

606. If the location changes, obtain track information of a change of the location of the interface control signal, where the track information includes a sliding track.

Specifically, if the location of the interface control signal changes within the preset time period, that is, the interface control signal does not stay at a location in the display interface, but moves, the processor 160 controls the sensor 140 or the input module 130 to obtain the track information of the interface control signal. The track information of the interface control signal includes the sliding track of the interface control signal.

607. Determine, as a target movable object, a movable object through which the sliding track passes.

Specifically, because the track information of the interface control signal includes the sliding track of the interface control signal, the processor 160 determines, as the target movable object, the movable object through which the sliding track of the interface control signal passes.

608. Obtain a display location of the target movable object in the dynamic list, and lock the display location of the target movable object in the dynamic list.

For a specific implementation process of step 608 in this embodiment of the present invention, refer to a specific description about step 504 in Embodiment 5 shown in FIG. 8 of the present invention, and details are not described herein again.

In this embodiment of the present invention, whether the interface control signal entered for the dynamic list is detected in the display interface of the display is determined, and the dynamic list includes the plurality of movable objects whose display locations are changeable; the location information of the interface control signal is obtained when the interface control signal is detected; the target movable object is determined in the dynamic list according to the location information of the interface control signal; and the display location of the target movable object in the dynamic list is obtained, and the display location of the target movable object in the dynamic list is locked. Therefore, a movable object required by a user is locked, so that the user accurately enters a content display interface of the required movable object, thereby improving user experience.

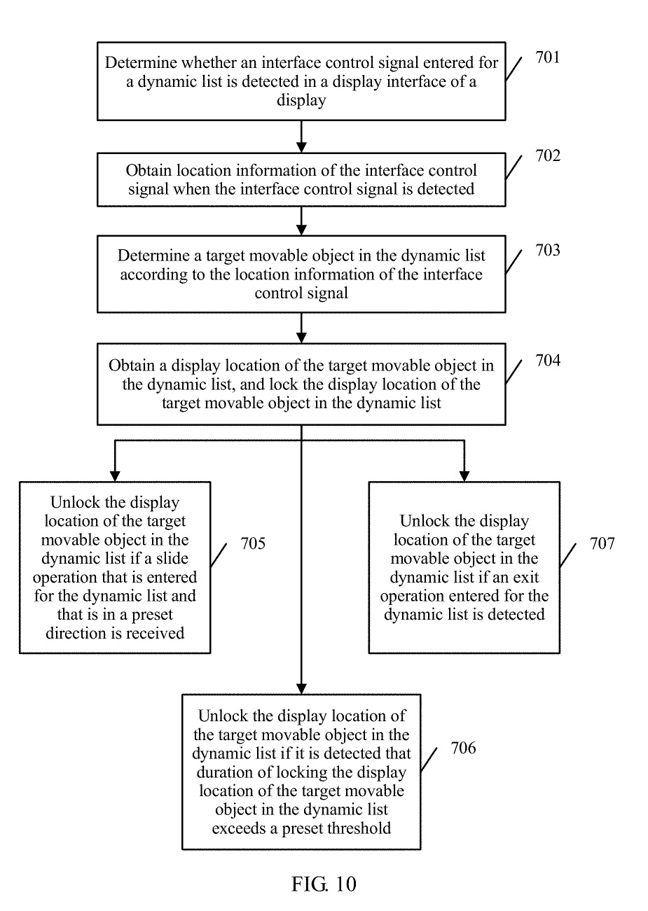

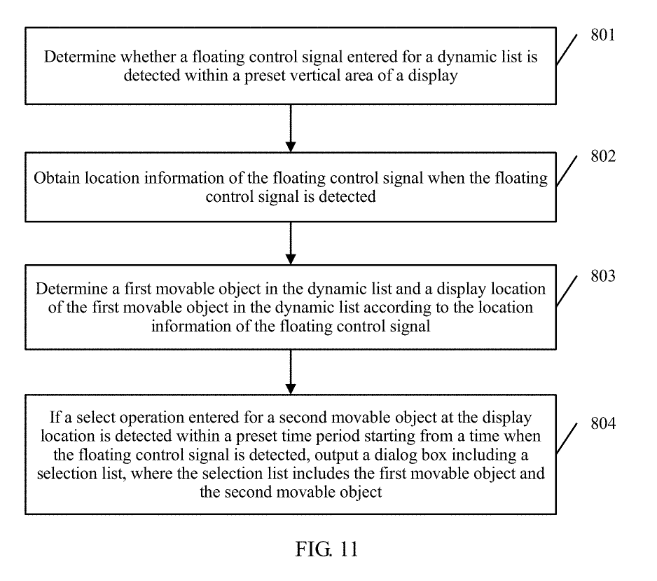

Referring to FIG. 10, FIG. 10 is a schematic flowchart of a method for locking an object in a list according to Embodiment 7 of the present invention. With reference to the terminal device shown in FIG. 1, the memory 180 stores a group of program code, and the processor 160 invokes the program code stored in the memory 180, to perform the method for locking an object in a list. The method may include the following step 701 to step 707.

701. Determine whether an interface control signal entered for a dynamic list is detected in a display interface of a display, where the dynamic list includes a plurality of movable objects whose display locations are changeable.

702. Obtain location information of the interface control signal when the interface control signal is detected.

703. Determine a target movable object in the dynamic list according to the location information of the interface control signal.

704. Obtain a display location of the target movable object in the dynamic list, and lock the display location of the target movable object in the dynamic list.

For specific implementation processes of step 701 to step 704 in this embodiment of the present invention, refer to specific descriptions about step 501 to step 504 in Embodiment 5 shown in FIG. 8 of the present invention, and details are not described herein again.

705. Unlock the display location of the target movable object in the dynamic list if a slide operation that is entered for the dynamic list and that is in a preset direction is received.

706. Unlock the display location of the target movable object in the dynamic list if it is detected that duration of locking the display location of the target movable object in the dynamic list exceeds a preset threshold.

707. Unlock the display location of the target movable object in the dynamic list if an exit operation entered for the dynamic list is detected.

For specific implementation processes of step 705 to step 707 in this embodiment of the present invention, refer to specific descriptions about step 405 to step 407 in Embodiment 4 shown in FIG. 7 of the present invention, and details are not described herein again.

In this embodiment of the present invention, after the display location of the target movable object in the dynamic list is locked, the target movable object may be unlocked according to an operation entered by the user, to restore the target movable object to an initial status, so that the user enters another operation.

It should be noted that, step 705, step 706, and step 707 are three parallel steps, and only one of the steps needs to be performed. Step 705, step 706, and step 707 may be performed after step 504 is performed in Embodiment 5, or may be performed after step 608 is performed in Embodiment 6.

It should be noted that, Embodiment 1 to Embodiment 4 of the present invention are applicable to a terminal device with a touch display, for example, a mobile phone or a tablet computer, and Embodiment 4 to Embodiment 7 of the present invention are applicable to a terminal device such as a mobile phone, a tablet computer, a notebook computer, or a desktop computer.

Referring to FIG. 11, FIG. 11 is a schematic flowchart of a method for locking an object in a list according to Embodiment 8 of the present invention. With reference to the terminal device shown in FIG. 1, the memory 180 stores a group of program code, and the processor 160 invokes the program code stored in the memory 180, to perform the method for locking an object in a list. The method may include the following step 801 to step 804.

801. Determine whether a floating control signal entered for a dynamic list is detected within a preset vertical area of a display, where the floating control signal includes a plurality of movable objects whose display locations are changeable.

802. Obtain location information of the floating control signal when the floating control signal is detected.

For specific implementation processes of step 801 and step 802 in this embodiment of the present invention, refer to specific descriptions about step 101 and step 102 in Embodiment 1 shown in FIG. 2 of the present invention, and details are not described herein again.

803. Determine a first movable object in the dynamic list and a display location of the first movable object in the dynamic list according to the location information of the floating control signal.

Specifically, a process in which the processor 160 determines the first movable object in the dynamic list and the display location of the first movable object in the dynamic list according to the location information of the floating control signal is a process of determining a target movable object and a process of obtaining a display location of the target movable object in the dynamic list in the previous seven embodiments. Details are not described herein again.

804. If a select operation entered for a second movable object at the display location is detected within a preset time period starting from a time when the floating control signal is detected, output a dialog box including a selection list, where the selection list includes the first movable object and the second movable object.

Specifically, the display location of the first movable object in the dynamic list is not locked in this embodiment of the present invention. Therefore, a display location of a movable object in the dynamic list may change at any time according to an update parameter or an update instruction. The display location of the first movable object in the dynamic list may change, and another movable object other than the first movable object may be displayed at the display location. The processor 160 detects whether the first movable object at the display location switches over to the second movable object, and detects, after the switchover occurs, whether the input module 130 receives, within the preset time period, the select operation entered for the second movable object. It may be understood that, the user enters the control signal at a specific moment, and the processor 160 determines the display location A of the first movable object according to the control signal. However, because the input module 130 receives the update parameter or the update instruction, the second movable object becomes a display object at the display location A. In this case, the processor 160 detects whether the input module 130 receives the select operation for the second movable object within the preset time period. The preset time period may be the same as the preset time period in the previous seven embodiments, or may be different from that in the previous seven embodiments. This is not limited herein. If the select operation entered for the second movable object at the display location is detected within the preset time period, the processor 160 controls the output module 170 to output the dialog box including the selection list, and the selection list includes the first movable object and the second movable object, so that the user selects, according to the dialog box, to enter a content display interface of a specific movable object, thereby improving user experience. In some cases, the user originally intends to select the first movable object. However, because the display location changes, the second movable object becomes an object displayed at the display location corresponding to the first movable object. If the user directly enters the select operation, the user selects the second movable object, and the processor 160 controls to jump to a content display interface of the second movable object, resulting in mistaken selection. In this embodiment of the present invention, after a display object at a display location changes, a dialog box including a movable object existing before the change and a movable object obtained after the change is provided for the user for selection, so as to select a required movable object.

It should be noted that, there may be more than one first movable object. If there is more than one first movable object, provided that a display object at a display location of any one of the first movable objects changes, the processor 160 controls the output module 170 to output a dialog box of a selection list including a movable object existing before the change and a movable object obtained after the change.

In this embodiment of the present invention, after a display object at a display location or display objects at several display locations change, a dialog box including a movable object existing before the change and a movable object obtained after the change is output, so that a user selects a required movable object according to the dialog box, thereby improving user experience.

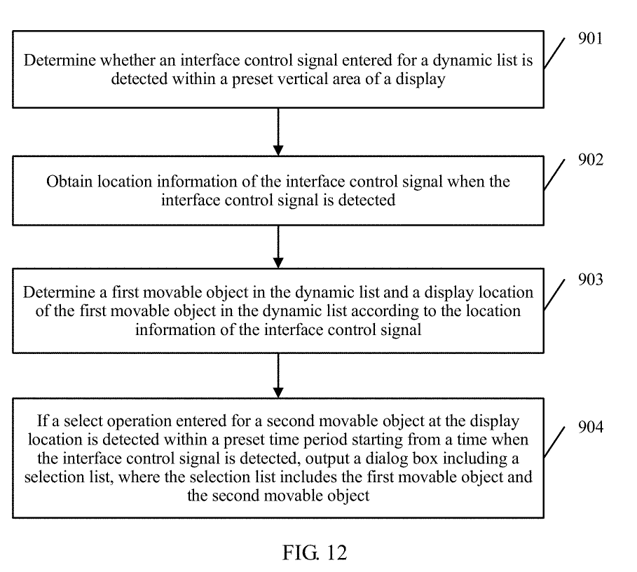

Referring to FIG. 12, FIG. 12 is a schematic flowchart of a method for locking an object in a list according to Embodiment 9 of the present invention. With reference to the terminal device shown in FIG. 1, the memory 180 stores a group of program code, and the processor 160 invokes the program code stored in the memory 180, to perform the method for locking an object in a list. The method may include the following step 901 to step 904.

901. Determine whether an interface control signal entered for a dynamic list is detected within a preset vertical area of a display, where the interface control signal includes a plurality of movable objects whose display locations are changeable.

902. Obtain location information of the interface control signal when the interface control signal is detected.

For specific implementation processes of step 901 and step 902 in this embodiment of the present invention, refer to specific descriptions about step 501 and step 502 in Embodiment 5 shown in FIG. 8 of the present invention, and details are not described herein again.

903. Determine a first movable object in the dynamic list and a display location of the first movable object in the dynamic list according to the location information of the interface control signal.

904. If a select operation entered for a second movable object at the display location is detected within a preset time period starting from a time when the interface control signal is detected, output a dialog box including a selection list, where the selection list includes the first movable object and the second movable object.

For specific implementation processes of step 903 and step 904 in this embodiment of the present invention, refer to specific descriptions about step 803 and step 804 in Embodiment 5 shown in FIG. 11 of the present invention, and details are not described herein again.

In this embodiment of the present invention, after a display object at a display location or display objects at several display locations change, a dialog box including a movable object existing before the change and a movable object obtained after the change is output, so that a user selects a required movable object according to the dialog box, thereby improving user experience.

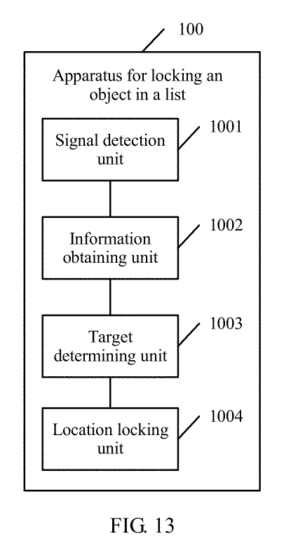

Referring to FIG. 13, FIG. 13 is a schematic structural diagram of an apparatus for locking an object in a list according to the present invention. The apparatus 100 for locking an object in a list may include a signal detection unit 1001, an information obtaining unit 1002, a target determining unit 1003, and a location locking unit 1004.

In a possible implementation:

the signal detection unit 1001 is configured to determine whether a floating control signal entered for a dynamic list is detected within a preset vertical area of a display, where the dynamic list includes a plurality of movable objects whose display locations are changeable; and

the information obtaining unit 1002 is configured to obtain location information of the floating control signal when the floating control signal is detected.

The information obtaining unit includes a location detection unit and a location determining unit, which are not marked in FIG. 13.

The location detection unit is configured to determine whether a location of the floating control signal changes within a preset time period starting from a time when the floating control signal is detected.

The location determining unit is configured to: if the location does not change, determine a stay location of the floating control signal as the location information of the floating control signal.

Alternatively, the location determining unit is configured to: if the location changes, obtain track information of a change of the location of the floating control signal, and determine the track information as the location information of the floating control signal.

The target determining unit 1003 is configured to determine a target movable object in the dynamic list according to the location information of the floating control signal.

The target determining unit 1003 is configured to determine two movable objects as the target movable objects if a location of vertical projection of the stay location of the floating control signal on the display is in selection areas of the two movable objects.

Alternatively, the target determining unit 1003 is further configured to determine one movable object as the target movable object if a location of vertical projection of the stay location of the floating control signal on the touch display is in a selection area of the movable object.

Alternatively, the track information includes an initial location and a sliding direction, and the target determining unit 1003 is configured to determine, as the target movable objects, all or a preset quantity of movable objects that are in the sliding direction of the air gesture and that start from a movable object corresponding to a location of vertical projection of the initial location on the display.

Alternatively, the track information includes a moving track, and the target determining unit 1003 is configured to determine, as the target movable object, a movable object covered by an area of vertical projection of the moving track on the display.

The location locking unit 1004 is configured to obtain a display location of the target movable object in the dynamic list, and lock the display location of the target movable object in the dynamic list.

The apparatus for locking an object in a list that is shown in this embodiment of the present invention is configured to implement the methods for locking an object in a list that are described in Embodiment 1 to Embodiment 3 of the present invention. For a brought technical effect and a specific principle, refer to specific descriptions in Embodiment 1 to Embodiment 3, and details are not described herein again.

In another possible implementation:

the signal detection unit 1001 is configured to determine whether an interface control signal entered for a dynamic list is detected in a display interface of a display, where the dynamic list includes a plurality of movable objects whose display locations are changeable; and

the information obtaining unit 1002 is configured to obtain location information of the interface control signal when the interface control signal is detected.

The information obtaining unit includes a location detection unit and a location determining unit, which are not marked in FIG. 13.

The location detection unit is configured to determine whether a location of the interface control signal changes within a preset time period starting from a time when the interface control signal is detected.

The location determining unit is configured to: if the location does not change, determine a stay location of the interface control signal as the location information of the interface control signal.

Alternatively, the location determining unit is configured to: if the location changes, obtain track information of a change of the location of the interface control signal, and determine the track information as the location information of the interface control signal.

The target determining unit 1003 is configured to determine a target movable object in the dynamic list according to the location information of the interface control signal.

The target determining unit 1003 is configured to determine two movable objects as the target movable objects if the stay location of the interface control signal is in selection areas of the two movable objects.

Alternatively, the target determining unit 1003 is further configured to determine one movable object as the target movable object if the stay location of the interface control signal is in a selection area of the movable object.

The track information includes a sliding track, and the target determining unit 1003 is further configured to determine, as the target movable object, a movable object through which the sliding track of the interface control signal passes.

The location locking unit 1004 is configured to obtain a display location of the target movable object in the dynamic list, and lock the display location of the target movable object in the dynamic list.

The apparatus for locking an object in a list that is shown in this embodiment of the present invention is configured to implement the methods for locking an object in a list that are described in Embodiment 5 and Embodiment 6 of the present invention. For a brought technical effect and a specific principle, refer to specific descriptions in Embodiment 5 and Embodiment 6, and details are not described herein again.

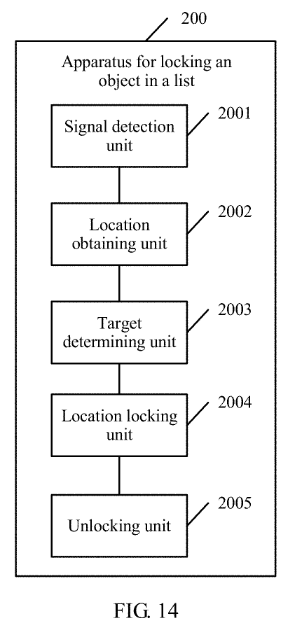

Referring to FIG. 14, FIG. 14 is a schematic structural diagram of another apparatus for locking an object in a list according to the present invention. The apparatus 200 for locking an object in a list may include a signal detection unit 2001, an information obtaining unit 2002, a target determining unit 2003, a location locking unit 2004, and an unlocking unit 2005. For specific implementation processes of the signal detection unit 2001, the location obtaining unit 2002, the target determining unit 2003, and the location locking unit 2004, refer to specific descriptions about the signal detection unit 1001, the location obtaining unit 1002, the target determining unit 1003, and the location locking unit 1004 in the embodiment shown in FIG. 13, and details are not described herein again.

The unlocking unit 2005 is configured to unlock the display location of the target movable object in the dynamic list if a slide operation that is entered for the dynamic list and that is in a preset direction is received.

The unlocking unit 2005 is further configured to unlock the display location of the target movable object in the dynamic list if it is detected that duration of locking the display location of the target movable object in the dynamic list exceeds a preset threshold.

The unlocking unit 2005 is further configured to unlock the display location of the target movable object in the dynamic list if an exit operation entered for the dynamic list is detected.

The apparatus for locking an object in a list that is shown in FIG. 14 is configured to implement the methods for locking an object in a list that are described in Embodiment 5 and Embodiment 7 of the present invention. For a brought technical effect and a specific principle, refer to specific descriptions in Embodiment 5 and Embodiment 7, and details are not described herein again.

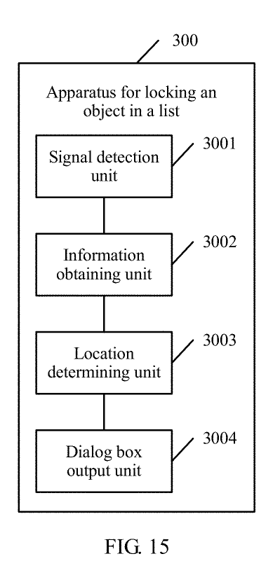

Referring to FIG. 15, FIG. 15 is a schematic structural diagram of still another apparatus for locking an object in a list according to the present invention. The apparatus 300 for locking an object in a list may include a signal detection unit 3001, an information obtaining unit 3002, a location determining unit 3003, and a dialog box output unit 3003.

In a possible implementation:

the signal detection unit 3001 is configured to determine whether a floating control signal entered for a dynamic list is detected within a preset vertical area of a display, where the floating control signal includes a plurality of movable objects whose display locations are changeable;

the information obtaining unit 3002 is configured to obtain location information of the floating control signal when the floating control signal is detected;

the location determining unit 3003 is configured to determine a first movable object in the dynamic list and a display location of the first movable object in the dynamic list according to the location information of the floating control signal; and

the dialog box output unit 3004 is configured to: if a select operation entered for a second movable object at the display location is detected within a preset time period starting from a time when the floating control signal is detected, output a dialog box including a selection list, where the selection list includes the first movable object and the second movable object.

In another possible implementation:

the signal detection unit 3001 is configured to determine whether an interface control signal entered for a dynamic list is detected in a display interface of a display, where the dynamic list includes a plurality of movable objects whose display locations are changeable;

the information obtaining unit 3002 is configured to obtain location information of the interface control signal when the interface control signal is detected;

the location determining unit 3003 is configured to determine a first movable object in the dynamic list and a display location of the first movable object in the dynamic list according to the location information of the interface control signal; and

the dialog box output unit 3004 is configured to: if a select operation entered for a second movable object at the display location is detected within a preset time period starting from a time when the interface control signal is detected, output a dialog box including a selection list, where the selection list includes the first movable object and the second movable object.

The apparatus for locking an object in a list that is shown in FIG. 15 is configured to implement the method for locking an object in a list that is described in Embodiment 8 or Embodiment 9 of the present invention. For a brought technical effect and a specific principle, refer to a specific description in Embodiment 8 or Embodiment 9, and details are not described herein again.

It should be noted that, for brief description, the foregoing method embodiments are represented as a series of actions. However, a person skilled in the art should appreciate that the present invention is not limited to the described order of the actions, because according to the present invention, some steps may be performed in other orders or simultaneously. In addition, a person skilled in the art should also appreciate that all the embodiments described in the specification are example embodiments, and the related actions and modules are not necessarily mandatory to the present invention.

In the foregoing embodiments, the description of each embodiment has respective focuses. For a part that is not described in detail in an embodiment, refer to related descriptions in other embodiments.

A sequence of the steps of the method in the embodiments of the present invention may be adjusted, and certain steps may also be merged or removed according to an actual need.

Merging, division, and removing may be performed on the units in the embodiments of the present invention according to an actual need. A person skilled in the art may integrate or combine different embodiments or characteristics of different embodiments described in the specification.

With descriptions of the foregoing implementations, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following is taken as an example but is not limited: The computer readable medium may include a random access memory (Random Access Memory, RAM), a read-only memory (Read-Only Memory, ROM), an electrically erasable programmable read-only memory (Electrically Erasable Programmable Read-Only Memory, EEPROM), a compact disc read-only memory (Compact Disc Read-Only Memory, CD-ROM) or other optical disk storage, a disk storage medium or other disk storage, or any other medium that can be used to carry or store expected program code in a command or data structure form and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (Digital Subscriber Line, DSL) or wireless technologies such as infrared ray, radio and microwave, the coaxial cable, optical fiber/cable, twisted pair, DSL or wireless technologies such as infrared ray, radio and microwave are included in a definition of a medium to which they belong. For example, a disk (Disk) and disc (disc) used by the present invention includes a compact disc CD, a laser disc, an optical disc, a digital versatile disc (DVD), a floppy disk, and a Blu-ray disc, where the disk usually copies data by a magnetic means, and the disc copies data optically by a laser means. The foregoing combination should also be included in the protection scope of the computer-readable medium.

In summary, what is described above is merely example embodiments of the technical solutions of the present invention, but is not intended to limit the protection scope of the present invention. Any modification, equivalent replacement, or improvement made without departing from the spirit and principle of the present invention shall fall within the protection scope of the present invention.

1. A method for locking an object in a list, comprising:
determining whether a floating control signal entered for a dynamic list is detected within a preset vertical area of a display, the dynamic list comprising a plurality of movable objects whose display locations are changeable;
obtaining location information of the floating control signal when the floating control signal is detected;
setting a target movable object in the dynamic list according to the location information of the floating control signal;
obtaining a display location of the target movable object in the dynamic list; and
locking the display location of the target movable object in the dynamic list.

2. The method of claim 1, wherein obtaining the location information of the floating control signal comprises:
determining whether a location of the floating control signal changes within a preset time period starting from a time when the floating control signal is detected;
setting a stay location of the floating control signal as the location information of the floating control signal when the location of the floating control signal does not change; and
obtaining track information of a change of the location of the floating control signal, and determining the track information as the location information of the floating control signal when the location of the floating control signal changes.

3. The method of claim 2, wherein setting the target movable object in the dynamic list comprises:
setting two movable objects as target movable objects when a location of a vertical projection of the stay location of the floating control signal on the display is in selection areas of the two movable objects; and
setting one movable object as the target movable object when the location of the vertical projection of the stay location of the floating control signal on the display is in a selection area of the movable object.

4. The method of claim 2, wherein the track information comprises an initial location and a sliding direction, and setting the target movable object in the dynamic list comprising setting all movable objects in the sliding direction that start from a movable object corresponding to a location of a vertical projection of the initial location on the display as target movable objects.

5. The method of claim 2, wherein the track information comprises a moving track, and setting the target movable object in the dynamic list comprising setting a movable object covered by an area of a vertical projection of the moving track on the display as the target movable object.

6. The method of claim 1, wherein after locking the display location of the target movable object in the dynamic list, the method further comprises unlocking the display location of the target movable object in the dynamic list when a slide operation entered for the dynamic list in a preset direction is received.

7. The method of claim 1, wherein after locking the display location of the target movable object in the dynamic list, the method further comprises unlocking the display location of the target movable object in the dynamic list when it is detected that duration of locking the display location of the target movable object in the dynamic list exceeds a preset threshold.

8. The method of claim 1, wherein after locking the display location of the target movable object in the dynamic list, the method further comprises unlocking the display location of the target movable object in the dynamic list when an exit operation entered for the dynamic list is detected.

9.-36. (canceled)

37. A terminal device, comprising:
a memory configured to store a group of program code; and
a processor coupled to the memory, the group of program code causing the processor to be configured to:
determine whether a floating control signal entered for a dynamic list is detected within a preset vertical area of a display, the dynamic list comprising a plurality of movable objects whose display locations are changeable;
obtain location information of the floating control signal when the floating control signal is detected;
set a target movable object in the dynamic list according to the location information of the floating control signal;
obtain a display location of the target movable object in the dynamic list; and
lock the display location of the target movable object in the dynamic list.

38. The terminal device of claim 37, wherein the group of program code further causes the processor to be configured to:
determine whether a location of the floating control signal changes within a preset time period starting from a time when the floating control signal is detected;
set a stay location of the floating control signal as the location information of the floating control signal when the location of the floating control signal does not change; and
obtain track information of a change of the location of the floating control signal, and set the track information as the location information of the floating control signal when the location of the floating control signal changes.

39. The terminal device of claim 38, wherein the group of program code further causes the processor to be configured to:
set two movable objects as target movable objects when a location of a vertical projection of the stay location of the floating control signal on the display is in selection areas of the two movable objects; and
set one movable object as the target movable object when the location of the vertical projection of the stay location of the floating control signal on the display is in a selection area of the movable object.

40. The terminal device of claim 38, wherein the track information comprises an initial location and a sliding direction, and the group of program code further causing the processor to be configured to set all movable objects in the sliding direction that start from a movable object corresponding to a location of a vertical projection of the initial location on the display as target movable objects.

41. The terminal device of claim 38, wherein the track information comprises a moving track, and the group of program code further causing the processor to be configured to set a movable object covered by an area of a vertical projection of the moving track on the display as the target movable object.

42. The terminal device of claim 37, wherein the group of program code further causes the processor to be configured to unlock the display location of the target movable object in the dynamic list when a slide operation entered for the dynamic list in a preset direction is received.

43. The terminal device of claim 37, wherein the group of program code further causes the processor to be configured to unlock the display location of the target movable object in the dynamic list when it is detected that duration of locking the display location of the target movable object in the dynamic list exceeds a preset threshold.

44. The terminal device of claim 37, wherein the group of program code further causes the processor to be configured to unlock the display location of the target movable object in the dynamic list when an exit operation entered for the dynamic list is detected.

45. The method of claim 2, wherein the track information comprises an initial location and a sliding direction, and setting the target movable object in the dynamic list comprising setting a preset quantity of movable objects in the sliding direction that start from a movable object corresponding to a location of a vertical projection of the initial location on the display as target movable objects.

46. The terminal device of claim 38, wherein the track information comprises an initial location and a sliding direction, and the group of program code further causing the processor to be configured to set a preset quantity of movable objects in the sliding direction that start from a movable object corresponding to a location of a vertical projection of the initial location on the display as target movable objects.
